(19) United States
(12) Patent Application Publication
(10) Pub. No.: US 2016/0267501 A1
(43) Pub. Date: Sep. 15, 2016

(54) CALCULATION METHOD AND APPARATUS FOR USER RETENTION RATIO

(71) Applicant: Beijing Gridsum Technology Co., Ltd., Beijing (CN)

(72) Inventors: Xin HU, Beijing (CN); Jibin Yang, Beijing (CN); Dan He, Beijing (CN); Fei Lin, Beijing (CN)

(21) Appl. No.: 15/160,341

(22) Filed: May 20, 2016

Related U.S. Application Data
(63) Continuation-in-part of application No. PCT/CN2014/090188, filed on Nov. 3, 2014.

(30) Foreign Application Priority Data
Nov. 20, 2013 (CN) 201310591083.1

(51) Int. Cl. G06Q 30/02; G06F 17/30

(52) U.S. Cl. CPC G06Q 30/0201; G06F 17/30483

(57) ABSTRACT

The disclosure discloses a calculation method and apparatus for a user retention ratio. The calculation method for a user retention ratio includes that: the number of first users in a first time period is acquired, the first users being users who have access to a target application for the first time; the number of second users in a second time period is acquired, the second users being users who have access to the target application not for the first time, and the second time period being a time period after the first time period; and a first number is compared with a second number to obtain a user retention ratio, the first number being the number of the first users in the first time period, and the second number being the number of the second users in the second time period. By means of the disclosure, the problem in the traditional art that the speed and efficiency of a mode of calculating a user retention ratio are low is solved, thereby achieving the effects of improving the calculation speed and the calculation efficiency.

### FIELD OF THE INVENTION

The disclosure relates to the field of data processing, and in particular to a calculation method and apparatus for a user retention ratio.

### BACKGROUND OF THE INVENTION

In the internet industry, particularly mobile applications, game applications or the like, an application owner pays more attention to retention users and a retention ratio, which can embody the quality of an application and a user retention capability from a point of view. The retention users refer to users who start to use applications in a certain period of time and are able to still use the applications continuously after a period of time in the internet industry, and a ratio of the retention users to currently added users is the retention ratio.

In a current technology, in order to acquire a retention ratio of users, it is necessary to judge whether a certain user performs access for the first time in each time period, to search whether the user performs access again within a certain specific time range, to judge and search each user, and then to calculate a retention ratio in a certain period. Due to the fact that it is necessary to query and compare time periods and a continuous value of a time period after a continuous time period is queried each time, the efficiency is quite low, and particularly under the condition that the number of users and the data volume are huge, the processing speed and efficiency are lower.

An effective solution is not proposed currently for the problem in the relevant art that the speed and efficiency of a mode of calculating a user retention ratio are low.

### SUMMARY OF THE INVENTION

The disclosure is mainly intended to provide a calculation method and apparatus for a user retention ratio, which are used to solve the problem in the traditional art that the speed and efficiency of a mode of calculating a user retention ratio are low.

In order to achieve the aim, according to one aspect of the disclosure, a calculation method for a user retention ratio is provided, which may include that: the number of first users in a first time period is acquired, the first users being users who have access to a target application for the first time; the number of second users in a second time period is acquired, the second users being users who have access to the target application not for the first time, and the second time period being a time period after the first time period; and a first number is compared with a second number to obtain a user retention ratio, the first number being the number of the first users in the first time period, and the second number being the number of the second users in the second time period.

Furthermore, the second time period may include a plurality of sub time periods, wherein the step that the number of the second users in the second time period is acquired may include that: the number of second users corresponding to each sub time period is acquired, second users corresponding to a first sub time period being users who directly log in the first sub time period, and the first sub time period being any one sub time period among the plurality of sub time periods. The step that the first number is compared with the second number to obtain the user retention ratio may include that: the first number is compared with the number of the second users corresponding to the first sub time period to obtain a first sub time period retention ratio; and the first number is compared with the number of second users corresponding to a second sub time period to obtain a second sub time period retention ratio, the second sub time period being any one sub time period, different from the first sub time period, among the plurality of sub time periods.

Furthermore, the step that the number of the first users in the first time period is acquired may include that: the first users are identified; and the first users are filtered using the first time period to obtain the number of the first users in the first time period. The step that the number of the second users in the second time period is acquired may include that: the second users are identified; and the second users are filtered using the second time period to obtain the number of the second users in the second time period.

Furthermore, the first users and the second users may be identified in following modes: acquiring an identifier of an access user; judging whether the acquired identifier is stored in a pre-set database, identifiers of the users having access to the target application being stored in the pre-set database; when it is judged that the acquired identifier is not stored in the pre-set database, determining the access user as one of the first users; and when it is judged that the acquired identifier is stored in the pre-set database, determining the access user as one of the second users.

Furthermore, when it is judged that the acquired identifier is not stored in the pre-set database, the calculation method may further include that: the acquired identifier is stored to the pre-set database.

Furthermore, the identifier of the access user may include a user name of the access user and/or a registered account of the access user.

Furthermore, after the first sub time period retention ratio and the second sub time period retention ratio are obtained, the calculation method may further include that: the first sub time period retention ratio is stored, and a time unit of the first sub time period retention ratio is marked as the first sub time period; and the second sub time period retention ratio is stored, and a time unit of the second sub time period retention ratio is marked as the second sub time period.

In order to achieve the aim, according to another aspect of the disclosure, a calculation apparatus for a user retention ratio is provided. The calculation apparatus is configured to execute the calculation method for a user retention ratio provided by the above-mentioned contents of the disclosure.

In order to achieve the aim, according to another aspect of the disclosure, a calculation apparatus for a user retention ratio is provided, which may include: a first acquisition unit, configured to acquire the number of first users in a first time period, the first users being users who have access to a target application for the first time; a second acquisition unit, configured to acquire the number of second users in a second time period, the second users being users who have access to the target application not for the first time, and the second time period being a time period after the first time period; and a comparison unit, configured to compare a first number with a second number to obtain a user retention ratio, the first number being the number of the first users in the first time period, and the second number being the number of the second users in the second time period.

Furthermore, the second time period may include a plurality of sub time periods, wherein the second acquisition unit includes: an acquisition module, configured to acquire the number of second users corresponding to each sub time period, second users corresponding to a first sub time period being users who directly log in the first sub time period, and the first sub time period being any one sub time period among the plurality of sub time periods. The comparison unit may include: a first comparison module, configured to compare the first number with the number of the second users corresponding to the first sub time period to obtain a first sub time period retention ratio; and a second comparison module, configured to compare the first number with the number of second users corresponding to a second sub time period to obtain a second sub time period retention ratio, the second sub time period being any one sub time period, different from the first sub time period, among the plurality of sub time periods.

Furthermore, the first acquisition unit may include: a first identification module, configured to identify the first users; and a first filtering module, configured to filter the first users using the first time period to obtain the number of the first users in the first time period. The second acquisition unit may include: a second identification module, configured to identify the second users; and a second filtering module, configured to filter the second users using the second time period to obtain the number of the second users in the second time period.

Furthermore, the calculation apparatus may further include: a third acquisition unit, configured to acquire an identifier of an access user; a judgment unit, configured to judge whether the acquired identifier is stored in a pre-set database, identifiers of the users having access to the target application being stored in the pre-set database; a first determination unit, configured to determine the access user as one of the first users when it is judged that the acquired identifier is not stored in the pre-set database; and a second determination unit, configured to determine the access user as one of the second users when it is judged that the acquired identifier is stored in the pre-set database.

Furthermore, the calculation apparatus may further include: a storage unit, configured to store the acquired identifier to the pre-set database when it is judged that the acquired identifier is not stored in the pre-set database.

Furthermore, the identifier of the access user may include a user name of the access user and/or a registered account of the access user.

Furthermore, the calculation apparatus may further include: a first processing unit, configured to store the first sub time period retention ratio, and mark a time unit of the first sub time period retention ratio as the first sub time period; and a second processing unit, configured to store the second sub time period retention ratio, and mark a time unit of the second sub time period retention ratio as the second sub time period.

By means of the disclosure, the number of the first users in the first time period is acquired, the first users being the users who have access to the target application for the first time; the number of the second users in the second time period is acquired, the second users being the users who have access to the target application not for the first time, and the second time period being the time period after the first time period; and the first number is compared with the second number to obtain the user retention ratio, the first number being the number of the first users in the first time period, and the second number being the number of the second users in the second time period. The user retention ratio is obtained by directly acquiring the number of new users namely the first users in a previous time period, directly acquiring the number of non-new users namely the second users in a subsequent time period and then comparing the two acquired numbers. Compared with a complicated calculation mode in the traditional art, this calculation mode has the advantages that the calculation speed and efficiency are obviously improved, and the problem in the traditional art that the speed and efficiency of a mode of calculating a user retention ratio are low is solved, thereby achieving the effects of improving the calculation speed and the calculation efficiency.

### BRIEF DESCRIPTION OF THE DRAWINGS

The drawings forming a part of the disclosure are intended to provide further understanding of the disclosure. The schematic embodiments and descriptions of the disclosure are intended to explain the disclosure, and do not form improper limits to the disclosure. In the drawings:

FIG. 1 is a flowchart of a calculation method for a user retention ratio according to an embodiment of the disclosure;

FIG. 2 is a flowchart of calculation of user retention ratios in different time indexes in a calculation method for a user retention ratio according to an embodiment of the disclosure; and

FIG. 3 is a diagram of a calculation apparatus for a user retention ratio according to an embodiment of the disclosure.

### DETAILED DESCRIPTION OF THE INVENTION

It is important to note that the embodiments of the disclosure and the characteristics in the embodiments can be combined under the condition of no conflicts. The disclosure is described in detail below with reference to the drawings and the embodiments.

An embodiment of the disclosure provides a calculation method for a user retention ratio. The calculation method for a user retention ratio provided by the embodiment of the disclosure is specifically introduced below.

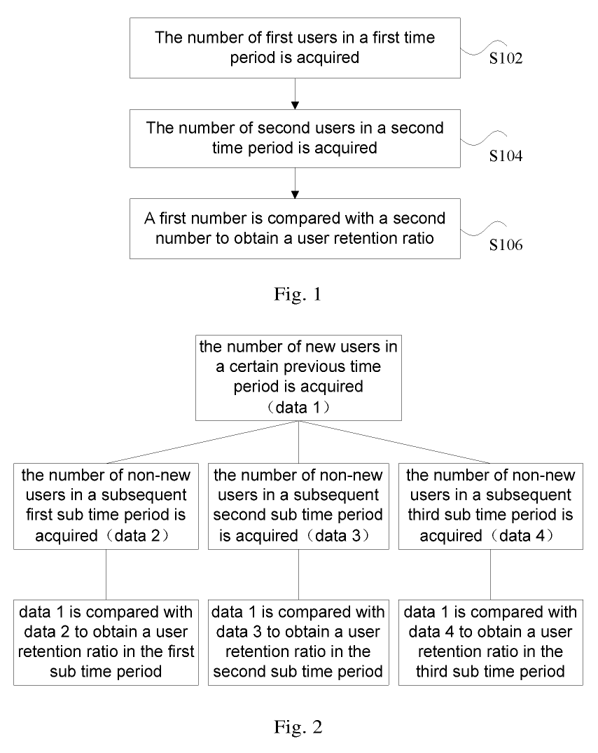

FIG. 1 is a flowchart of a calculation method for a user retention ratio according to an embodiment of the disclosure. As shown in FIG. 1, the method includes Step S102 to Step S106 as follows.

S102: The number of first users in a first time period is acquired, the first users being users who have access to a target application for the first time.

S104: The number of second users in a second time period is acquired, the second users being users who have access to the target application not for the first time, and the second time period being a time period after the first time period. Namely, the number of non-new users in a subsequent time period is acquired, the second users being part of the first users.

S106: A first number is compared with a second number to obtain a user retention ratio, the first number being the number of the first users in the first time period, and the second number being the number of the second users in the second time period. Specifically, a ratio of the first number to the second number can be calculated as the user retention ratio, and a time index of the user retention ratio is the second time period.

By means of the calculation method for a user retention ratio provided by the embodiment of the disclosure, the user retention ratio is obtained by directly acquiring the number of the new users namely the first users in the previous time period, directly acquiring the number of the non-new users namely the second users in the subsequent time period and then comparing the two acquired numbers. Compared with the complicated calculation mode in the traditional art, this calculation mode has the advantages that the calculation speed and efficiency are obviously improved, and the problem in the traditional art that the speed and efficiency of a mode of calculating a user retention ratio are low is solved, thereby achieving the effects of improving the calculation speed and the calculation efficiency.

The second users in the second time period are part of the first users in the first time period, wherein the first users are users who perform access in the first time period for the first time, and the second users are first users who perform access again in the second time period, namely the second users are first users who act in the second time period.

Specifically, the second time period can include a plurality of sub time periods, wherein in the step that the number of the second users in the second time period is acquired, it is necessary to acquire the number of second users corresponding to each sub time period. Suppose a first sub time period is any one sub time period among the plurality of sub time periods, second users corresponding to the first sub time period are second users who directly log in the first sub time period. The plurality of sub time periods in the second time period can be in a continuous distribution mode, a discrete distribution mode, a mutual overlapping mode, a complete coverage mode or in a mode of combining random modes. As long as any one of corresponding starting and end points of the two sub time periods is different, the two sub time periods are considered as two different sub time periods, and how to select a sub time period can be determined according to usage requirements specifically.

Correspondingly, the step that the first number is compared with the second number to obtain the user retention ratio specifically includes that: the first number is compared with the number of the second users corresponding to each sub time period to obtain a corresponding sub time period retention ratio, namely the first number is compared with the number of the second users corresponding to the first sub time period to obtain a first sub time period retention ratio, and the first number is compared with the number of second users corresponding to a second sub time period to obtain a second sub time period retention ratio, the second sub time period being any one sub time period, different from the first sub time period, among the plurality of sub time periods. Wherein, the step that the first number and the second number are calculated refers to that the first number and the second number have been calculated and stored in advance at a specific time point prior to the step of calculating the user retention ratio. Specific calculation time and a specific storage mode can be carried out according to pre-settings.

By acquiring the number of the non-new users in each sub time period and comparing the number with the first number, the user retention ratios in different time indexes can be calculated.

By taking the sub time periods including a day time period (first sub time period), a week time period (second sub time period) and a month time period (third sub time period) as an example, the calculation of the user retention ratios in the different time indexes in the calculation method for a user retention ratio according to the embodiment of the disclosure is further specifically described below.

FIG. 2 is a flowchart of calculation of user retention ratios in different time indexes in a calculation method for a user retention ratio according to an embodiment of the disclosure. As shown in FIG. 2, the number of new users in a certain previous time period (a certain day, as assumed) is acquired, firstly, as data 1, and then the number of non-new users in a next day after this day is acquired as data 2, wherein when the number of the non-new users on the next day is acquired, only the number of users who perform access again on the next day in the data 1 is acquired; the number of non-new users in a week after this day is acquired as data 3, wherein when the number of the non-new users in the week is acquired, only the number of users who perform access again in the week in the data 1 is acquired; and the number of non-new users in a month after this day is acquired as data 4, wherein when the number of the non-new users in the month is acquired, only the number of users who perform access again in the month in the data 1 is acquired. The data 1 is compared with the data 2 to obtain a user retention ratio in the first sub time period namely a day retention ratio; the data 1 is compared with the data 3 to obtain a user retention ratio in the second sub time period namely a week retention ratio; and the data 1 is compared with the data 4 to obtain a user retention ratio in the third sub time period namely a month retention ratio. The user retention ratio can be calculated when each time period is ended periodically. For example, the user retention ratio can be calculated at 23:59 every day, can be calculated when each week is ended, or can be calculated when each month is ended. Preferably, the user retention ratios can be uniformly calculated as needed. For example, the number of new users and the number of retention users are calculated periodically and stored in a database of a server, in order that corresponding data is directly extracted from the database for subsequent calculation as needed. During calculation, the day retention ratio, the week retention ratio and the month retention ratio can also be calculated respectively.

It is important to note that the first sub time period, the second sub time period and the third sub time period are only illustrated. In the embodiment of the disclosure, time lengths of any two sub time periods among the plurality of sub time periods can be equal or unequal. For example, if each of the first sub time period, the second sub time period and the third sub time period refers to a day, the user retention ratio in the first sub time period is a next day retention ratio, the user retention ratio in the second sub time period is a second day retention ratio, and the user retention ratio in the third sub time period is a third day retention ratio.

Furthermore, after the user retention ratio in each sub time period is obtained, the calculation method for a user retention ratio according to the embodiment of the disclosure further includes that: a retention ratio in each sub time period is stored, and a time unit of the retention ratio in each sub time period is marked as a corresponding sub time period. For example, after a first sub time period retention ratio and a second sub time period retention ratio are obtained, the first sub time period retention ratio is stored, a time unit of the first sub time period retention ratio is marked as the first sub time period, the second sub time period retention ratio is stored, and a time unit of the second sub time period retention ratio is marked as the second sub time period. Namely, after each sub time period is ended, a user retention number (the number of non-new users) in each sub time period is calculated, the user retention ratio in each sub time period is calculated, and each calculated retention ratio is stored according to corresponding unit time. Namely, the retention ratios are stored respectively according to different indexes (for example, day retention, week retention and month retention) to facilitate query, direct invoking and the like. In the embodiment of the disclosure, the step that the number of the first users in the first time period is acquired can include that: the first users are identified; and the first users are filtered using the first time period to obtain the number of the first users in the first time period. The step that the number of the second users in the second time period is acquired can include that: the second users are identified; and the second users are filtered using the second time period to obtain the number of the second users in the second time period.

As illustrated below, all users who perform access for the first time are marked as new users namely the first users. There is only one mark for each new user, only belonging to a certain unit time period (for example, day, week and month), the unit time period is also called a sub time period which may be a day, a week or a month, and the mark for a new user can carry first access time of the new user, and can carry an identifier representing that the user is a new day user, a new week user or a new month user. For example, if a user A performs access on September 1^{st} for the first time, the user A belongs to new users on September 1^{st}, at this moment, the user A is a first user, a new user (with respect to week retention) in a week containing the first day of September, and a new user (with respect to month retention) in September, and information of the user, such as unique identity information of the user, is saved when the user performs access for the first time. The first access time of the user can also be saved. After then, the user A performs access using a non-new user identifier each time. If the user A has access to an application again on September 2^{nd}, the user A should be marked as a non-new user during access, at this moment, the user A belongs to second users which are part of the first users, and however, the user A still belongs to new users in the week containing the first day of September and new users in September.

In the embodiment, suppose all new users in a unit time period form data 1, users in the data 1 may have access to an application as non-new users in any subsequent unit time period. Suppose non-new users having access to an application in a first subsequent unit time period form data 2 and non-new users having access to an application in a second subsequent unit time period form data 3, when a unit time period is ended, all user accesses in the unit time period are recorded, all new users in the time period are stored, and access time of a new user is also stored. If the non-new users in the unit time period must be new users in a certain previous unit time period, namely part of users in the data 2 or the data 3 are the users in the data 1, the number of the users in the data 1 is the number of retention users. Thus, after each unit time period is ended, the number of retention users in the unit time period with respect to a certain previous time period is calculated in batches when each day is ended, each week is ended and each month is ended for example. If part of users in the non-new users on September 1^{st} may be new users on August 31^{st}, the number of these users is a retention number on a next day with respect to August 31^{st}, part of users in the non-new users on September 1^{st} may be new users on August 30^{th} (retention users on two days after August 30^{th} are obtained), part of users may be new users on August 29^{th} (retention users on three days after August 29^{th} are obtained), the number of retention users with respect to a plurality of previous unit time periods is calculated in batches periodically after each unit time period is ended, namely the number of retention users is pre-calculated, data is stored after the number of retention users is calculated each time, and the data is stored according to different retention indexes such as day retention, week retention and month retention respectively so as to be capable of facilitating query via a query interface in a later stage to invoke the number of retention users to calculate a retention user ratio.

In the optional embodiment, new users in the data 1 are the first users, and the number of the new users in the data 1 is the first number; part of users in the data 2 are the users in the data 1, these users are the second users, and the number of these users is the second number; similarly, part of users in the data 3 are the users in the data 1, and the number of these users is the second number; and the first number and the second number are calculated and stored in the database in advance, namely pre-calculated, prior to the step of calculating the user retention ratio. By means of pre-calculation, the query time can be shortened, and the query efficiency can be improved.

Specifically, in the calculation method for a user retention ratio according to the embodiment of the disclosure, the first users and the second users can be identified in modes as follows.

Firstly, an identifier of an access user is acquired, wherein the identifier of the access user can be a user name of the access user, a registered account of the access user, or combined information of the user name and the registered account, namely, the user name of the access user can be acquired, a registered account of a login user can be acquired, or the user name and the registered account can be acquired at the same time, and it is only necessary to meet the requirement that the identifier of a certain specific access user is unique.

Secondly, it is judged whether the acquired identifier is stored in a pre-set database, wherein identifiers of the users having access to the target application are stored in the pre-set database.

Then, a process of identifying the first users and the second users is that: when it is judged that the acquired identifier is not stored in the pre-set database, the access user is determined as one of the first users; and when it is judged that the acquired identifier is stored in the pre-set database, the access user is determined as one of the second users. Namely, if the acquired identifier has been stored in the pre-set database, it is shown that the access user has access to an application, and the user is a non-new user. Otherwise, the user is a new user. Wherein, a process of identifying that the user is one of the first users is only an identification result obtained when the user has access to the target application for the first time, and at this moment, the user will be marked as a new user in a storage record corresponding to the user in the pre-set database. Wherein, there will be a field in a storage record of the pre-set database for each user to store the identifier marking the new user. A home terminal will count the first users and the second users in a pre-set time period according to the identifier stored in the field at a specific time point, and store the number of the first users and the number of the second users.

Furthermore, when it is judged that the acquired identifier is not stored in the pre-set database, the calculation method for a user retention ratio according to the embodiment of the disclosure further includes that: the acquired identifier is stored to the pre-set database, so the pre-set database can be updated to ensure that new users and non-new users can be accurately distinguished when it is judged whether the users are new users or not at next time.

An embodiment of the disclosure also provides a calculation apparatus for a user retention ratio. The calculation apparatus is mainly configured to execute any one calculation method for a user retention ratio provided by the above-mentioned contents of the embodiments of the disclosure. The calculation apparatus for a user retention ratio provided by the embodiment of the disclosure is specifically introduced below.

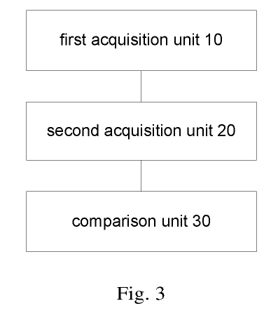

FIG. 3 is a diagram of a calculation apparatus for a user retention ratio according to an embodiment of the disclosure. As shown in FIG. 3, the calculation apparatus for a user retention ratio according to the embodiment mainly includes a first acquisition unit 10, a second acquisition unit 20 and a comparison unit 30.

The first acquisition unit 10 is configured to acquire the number of first users in a first time period, wherein the first users are users who have access to a target application for the first time. Namely, the number of new users in the first time period is acquired.

The second acquisition unit 20 is configured to acquire the number of second users in a second time period, wherein the second users are users who have access to the target application not for the first time, and the second time period is a time period after the first time period. Namely, the number of non-new users in a subsequent time period is acquired.

The comparison unit 30 is configured to compare a first number with a second number to obtain a user retention ratio, wherein the first number is the number of the first users in the first time period, and the second number is the number of the second users in the second time period. Specifically, a ratio of the first number to the second number can be calculated as the user retention ratio, and a time index of the user retention ratio is the second time period.

By means of the calculation apparatus for a user retention ratio provided by the embodiment of the disclosure, the user retention ratio is obtained by directly acquiring the number of the new users namely the first users in the previous time period, directly acquiring the number of the non-new users namely the second users in the subsequent time period and then comparing the two acquired numbers. Compared with the complicated calculation mode in the traditional art, this calculation mode has the advantages that the calculation speed and efficiency are obviously improved, and the problem in the traditional art that the speed and efficiency of a mode of calculating a user retention ratio are low is solved, thereby achieving the effects of improving the calculation speed and the calculation efficiency.

Specifically, the second time period can include a plurality of sub time periods. The second acquisition unit 20 mainly includes an acquisition module, configured to acquire the number of second users corresponding to each sub time period. Suppose a first sub time period is any one sub time period among the plurality of sub time periods, second users corresponding to the first sub time period are second users who directly log in the first sub time period. Wherein, there can be a plurality of acquisition modules, one of the acquisition modules being configured to acquire the number of second users in one sub time period. For example, a first acquisition module is configured to acquire the number of the second users in the first sub time period, and a second acquisition module is configured to acquire the number of the second users in the second sub time period, wherein the second sub time period is any one sub time period, different from the first sub time period, among the plurality of sub time periods.

Correspondingly, the comparison unit 30 mainly includes a comparison module, configured to compare the first number with the number of the second users corresponding to each sub time period to obtain a corresponding sub time period retention ratio. There can also be a plurality of comparison modules. A first comparison module is configured to compare the first number with the number of the second users corresponding to the first sub time period to obtain a first sub time period retention ratio, and a second comparison module, configured to compare the first number with the number of the second users corresponding to the second sub time period to obtain a second sub time period retention ratio.

Specifically, the first acquisition unit can include: a first identification module, configured to identify the first users; and a first filtering module, configured to filter the first users using the first time period to obtain the number of the first users in the first time period. The second acquisition unit includes: a second identification module, configured to identify the second users; and a second filtering module, configured to filter the second users using the second time period to obtain the number of the second users in the second time period.

By acquiring the number of the non-new users in each sub time period and comparing the number with the first number, the user retention ratios in different time indexes can be calculated.

Furthermore, the calculation apparatus for a user retention ratio according to the embodiment of the disclosure further includes a third acquisition unit, a judgment unit, a first determination unit and a second determination unit.

The third acquisition unit is configured to acquire an identifier of an access user, wherein the identifier of the access user can be a user name of the access user, a registered account of the access user, or combined information of the user name and the registered account, namely, the user name of the access user can be acquired, a registered account of a login user can be acquired, or the user name and the registered account can be acquired at the same time, and it is only necessary to meet the requirement that the identifier of a certain specific access user is unique.

The judgment unit is configured to judge whether the acquired identifier is stored in a pre-set database, wherein identifiers of the users having access to the target application are stored in the pre-set database.

The first determination unit is configured to determine the access user as one of the first users when it is judged that the acquired identifier is not stored in the pre-set database, and the second determination unit is configured to determine the access user as one of the second users when it is judged that the acquired identifier is stored in the pre-set database. Namely, if the acquired identifier has been stored in the pre-set database, it is shown that the access user has access to an application, and the user is a non-new user. Otherwise, the user is a new user.

Furthermore, the calculation apparatus for a user retention ratio according to the embodiment of the disclosure further includes a first storage unit, configured to store the acquired identifier to the pre-set database when it is judged that the acquired identifier is not stored in the pre-set database.

By storing the acquired identifier to the pre-set database, the pre-set database can be updated to ensure that new users and non-new users can be accurately distinguished when it is judged whether the users are new users or not at next time.

Furthermore, the calculation apparatus for a user retention ratio according to the embodiment of the disclosure further includes a processing unit, configured to store each sub time period retention ratio and mark a time unit of each sub time period retention ratio as a corresponding sub time period. For example, the calculation apparatus further includes a first processing unit and a second processing unit. After a first sub time period retention ratio and a second sub time period retention ratio are obtained, the first processing unit is configured to store the first sub time period retention ratio and mark a time unit of the first sub time period retention ratio as the first sub time period, and the second processing unit is configured to store the second sub time period retention ratio and mark a time unit of the second sub time period retention ratio as the second sub time period. Namely, after each sub time period is ended, a user retention number (the number of non-new users) in each sub time period is calculated, the user retention ratio in each sub time period is calculated, and each calculated retention ratio is stored according to corresponding unit time. Namely, the retention ratios are stored respectively according to different indexes (for example, day retention, week retention and month retention) to facilitate query, direct invoking and the like.

From the above description, it can be seen that the disclosure achieves a simplified mode of calculating a user retention ratio, and improves the calculation speed and the calculation efficiency.

It is important to note that the steps shown in flows of the drawings can be executed in a computer system including, for example, a set of computer executable instructions. Moreover, although a logical sequence is shown in the flowcharts, the shown or described steps can be executed in a sequence different from this sequence under certain conditions.

Obviously, those skilled in the art should understand that all modules or all steps in the disclosure can be realized by using a generic calculation apparatus, can be centralized on a single calculation apparatus or can be distributed on a network composed of a plurality of calculation apparatuses. Optionally, they can be realized by using executable program codes of the calculation apparatuses. Thus, they can be stored in a storage apparatus and executed by the calculation apparatuses, or they are manufactured into each integrated circuit module respectively, or a plurality of modules or steps therein are manufactured into a single integrated circuit module. Thus, the disclosure is not limited to a combination of any specific hardware and software.

The above is only the preferred embodiments of the disclosure, and is not intended to limit the invention. There can be various modifications and variations in the disclosure for those skilled in the art. Any modifications, equivalent replacements, improvements and the like within the spirit and principle of the disclosure shall fall within the protection scope of the invention.

What is claimed is:

1. A calculation method for a user retention ratio, comprising:
acquiring the number of first users in a first time period, the first users being users who have access to a target application for the first time;
acquiring the number of second users in a second time period, the second users being users who have access to the target application not for the first time, and the second time period being a time period after the first time period; and
comparing a first number with a second number to obtain a user retention ratio, the first number being the number of the first users in the first time period, and the second number being the number of the second users in the second time period.

2. The calculation method according to claim 1, wherein the second time period comprises a plurality of sub time periods,
acquiring the number of the second users in the second time period comprises:
acquiring the number of second users corresponding to each sub time period, the second users corresponding to a first sub time period being second users who directly log in the first sub time period, and the first sub time period being any one sub time period among the plurality of sub time periods; and
comparing the first number with the second number to obtain the user retention ratio comprises:
comparing the first number with the number of the second users corresponding to the first sub time period to obtain a first sub time period retention ratio; and
comparing the first number with the number of the second users corresponding to a second sub time period to obtain a second sub time period retention ratio, the second sub time period being any one sub time period, different from the first sub time period, among the plurality of sub time periods.

3. The calculation method according to claim 1, wherein
acquiring the number of the first users in the first time period comprises: identifying the first users; and filtering the first users using the first time period to obtain the number of the first users in the first time period; and
acquiring the number of the second users in the second time period comprises: identifying the second users; and filtering the second users using the second time period to obtain the number of the second users in the second time period.

4. The calculation method according to claim 3, wherein the first users and the second users are identified in following modes:
acquiring an identifier of an access user;
judging whether the acquired identifier is stored in a pre-set database, identifiers of users having access to the target application being stored in the pre-set database;
determining the access user as one of the first users when it is judged that the acquired identifier is not stored in the pre-set database; and
determining the access user as one of the second users when it is judged that the acquired identifier is stored in the pre-set database.

5. The calculation method according to claim 4, wherein when it is judged that the acquired identifier is not stored in the pre-set database, the calculation method further comprises:
storing the acquired identifier to the pre-set database.

6. The calculation method according to claim 4, wherein the identifier of the access user comprises a user name of the access user and/or a registered account of the access user.

7. The calculation method according to claim 2, wherein after the first sub time period retention ratio and the second sub time period retention ratio are obtained, the calculation method further comprises:
storing the first sub time period retention ratio, and marking a time unit of the first sub time period retention ratio as the first sub time period; and
storing the second sub time period retention ratio, and marking a time unit of the second sub time period retention ratio as the second sub time period.

8. A calculation apparatus for a user retention ratio, comprising:
a first acquisition unit, configured to acquire the number of first users in a first time period, the first users being users who have access to a target application for the first time;
a second acquisition unit, configured to acquire the number of second users in a second time period, the second users being users who have access to the target application not for the first time, and the second time period being a time period after the first time period; and
a comparison unit, configured to compare a first number with a second number to obtain a user retention ratio, the first number being the number of the first users in the first time period, and the second number being the number of the second users in the second time period.

9. The calculation apparatus according to claim 8, wherein the second time period comprises a plurality of sub time periods,
the second acquisition unit comprises: an acquisition module, configured to acquire the number of the second users corresponding to each sub time period, the second users corresponding to a first sub time period being second users who directly log in the first sub time period, and the first sub time period being any one sub time period among the plurality of sub time periods; and
the comparison unit comprises:
a first comparison module, configured to compare the first number with the number of the second users corresponding to the first sub time period to obtain a first sub time period retention ratio; and
a second comparison module, configured to compare the first number with the number of the second users corresponding to a second sub time period to obtain a second sub time period retention ratio, the second sub time period being any one sub time period, different from the first sub time period, among the plurality of sub time periods.

10. The calculation apparatus according to claim 8, wherein
the first acquisition unit comprises:
a first identification module, configured to identify the first users; and
a first filtering module, configured to filter the first users using the first time period to obtain the number of the first users in the first time period; and
the second acquisition unit comprises:
a second identification module, configured to identify the second users; and
a second filtering module, configured to filter the second users using the second time period to obtain the number of the second users in the second time period.

11. The calculation apparatus according to claim 10, further comprising:
a third acquisition unit, configured to acquire an identifier of an access user;
a judgment unit, configured to judge whether the acquired identifier is stored in a pre-set database, identifiers of users having access to the target application being stored in the pre-set database;
a first determination unit, configured to determine the access user as one of the first users when it is judged that the acquired identifier is not stored in the pre-set database; and
a second determination unit, configured to determine the access user as one of the second users when it is judged that the acquired identifier is stored in the pre-set database.

12. The calculation apparatus according to claim 11, further comprising:
a storage unit, configured to store the acquired identifier to the pre-set database when it is judged that the acquired identifier is not stored in the pre-set database.

13. The calculation apparatus according to claim 11, wherein the identifier of the access user comprises a user name of the access user and/or a registered account of the access user.

14. The calculation apparatus according to claim 9, further comprising:
a first processing unit, configured to store the first sub time period retention ratio, and mark a time unit of the first sub time period retention ratio as the first sub time period; and
a second processing unit, configured to store the second sub time period retention ratio, and mark a time unit of the second sub time period retention ratio as the second sub time period.
